(19) United States
(12) Patent Application Publication
(10) Pub. No.: US 2012/0127245 A1
(43) Pub. Date: May 24, 2012

(54) Pivot cover structure for ink cartridge

(76) Inventor: CHI-CHANG LIU, Chungli City (TW)

(21) Appl. No.: 12/949,018

(22) Filed: Nov. 18, 2010

(51) Int. Cl. B41J 2/175

(52) U.S. Cl. 347/86

(57) ABSTRACT

A pivot cover can incorporate with an ink cartridge to close an ink refill opening of the ink cartridge. The pivot cover has a cover body having a leaning portion, and a push member is extended from an end of the cover body while a fastening member is extended from another end of the cover body. The fastening member has a pivot hole. A pushing portion is disposed to an upper end of the push member while an embedding portion is disposed to a lower end of the push member, and the embedding portion protrudes the leaning portion. While pushing the pushing portion, the push member takes the pivot hole as an axle core to allow the pivot cover to rotably perform opening and closing motion so that the embedding portion can be positioned to allow the leaning portion to close the ink refill opening of the ink cartridge.

### BACKGROUND OF THE INVENTION

1. Field of the Invention

The present invention relates to a pivot cover structure for an ink cartridge, and more particularly to a pivot cover that is capable of being fastened to the ink cartridge and capable of being rotated to perform opening and closing functions.

2. Description of the Related Art

In a mass of computer peripheral equipment, a printer almost becomes one of computer peripheral equipment in widespread use. When an ink-jet printer performs printing, the related transmission mechanism drives an ink cartridge to spray ink on a paper medium. Ink is a consumable and can be stored in the ink cartridge through design. The empty ink cartridge can be conveniently replaced with new one when ink within the ink cartridge is used up.

Since the price of the ink-jet printer is inexpensive, the ink-jet printer is accepted by families. Moreover, since the market of the ink-jet printer is quite intense, each printer company gradually changes its marketing strategy. After the printer is sold to consumer, the printer company can easily charge expenses of consumables such as ink cartridges. The price of these ink cartridges is sometimes higher than the printer. To overcome the foregoing problem, a refilling ink cartridge is presented to the public. When ink within the refilling ink cartridge is exhausted, the ink cartridge can be timely filled with ink to have environmental protection and save the expense in consumable.

Presently, when ink within the refilling ink cartridge in the market is completely exhausted, the refilling ink cartridge can be continuously utilized by filling with ink. However, a common ink cartridge 50 has a plug 60 (as shown in FIG. 1). While refilling ink, an ear portion 61 must be firstly caught to pull the plug 60 out by imposing force so as to fill ink.

However, the foregoing conventional structure may easily have problem. When the ink is completely filled, an ink refill opening 51 then is immediately closed. The plug 60 may not be found to cause a serious issue that needs to be overcome.

### SUMMARY OF THE INVENTION

In view of the shortcomings of the prior art, the inventor(s) of the present invention based on years of experience in the related industry to conduct extensive researches and experiments, and finally developed a pivot cover structure for an ink cartridge that can be applied to the ink cartridge. More specifically, the structure can be fastened to the ink cartridge to achieve rotably opening and closing through pivot rotation and may not lose after pulling it out.

To achieve the foregoing objective, the structure has a cover body having a leaning portion, and a push member is extended from an end of the cover body while a fastening member is extended from another end of the cover body. Further, the fastening member has a pivot hole. A pushing portion is disposed to an upper end of the push member while a lower end of the push member has an embedding portion. The embedding portion protrudes the leaning portion. The features of the invention are that:
1. A shaft portion of the ink cartridge passes through the fastening member through the pivot hole of the fastening member to achieve simple and fast installation.
2. While pushing the pushing portion, the push member takes the pivot hole as an axle core to allow the pivot cover to perform the rotably opening and closing motions, thereby positioning the embedding portion, and the leaning portion is allowed to close an ink refill opening of the ink cartridge.

### BRIEF DESCRIPTION OF THE DRAWINGS

FIG. 1 is a structural diagram of a conventional ink cartridge plug;

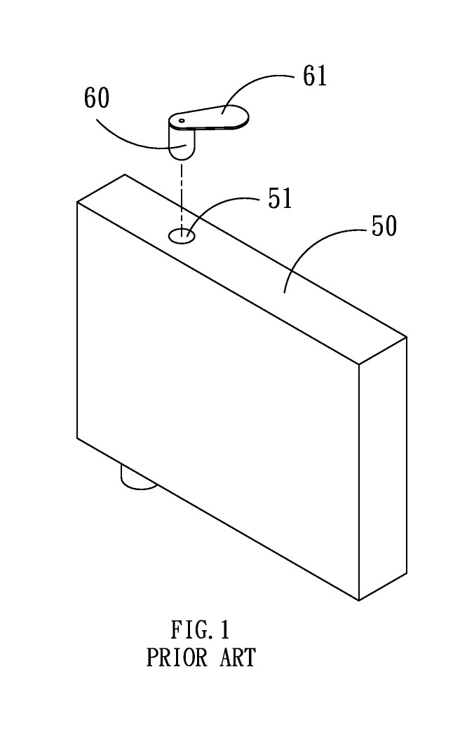

FIG. 2 is a structural diagram of a pivot cover structure according to the present invention;

FIG. 3 is a decomposition drawing of a structure according to the present invention;

FIG. 4 is a schematic diagram of using structure according to the present invention;

FIG. 5 is a schematic diagram of a structure according to the present invention; and

FIG. 6 is a schematic diagram of further using a structure according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

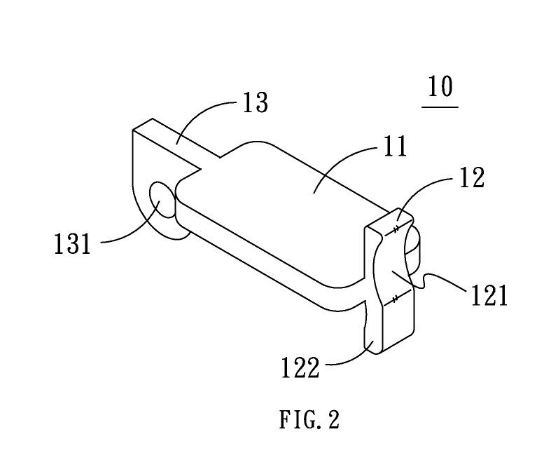

The objective of the invention is to provide a pivot cover capable of being fastened to an ink cartridge. As shown in FIG. 2, the pivot cover 10 is composed of a cover body 11, a push member 12 and a fastening member 13 and can be formed by integrated modeling.

The structure is that the cover body 11 has a leaning portion 111, wherein the push member 12 is extended from one end of the leaning portion 11 while the fastening member 13 is extended from another end of the leaning portion. Further, the fastening member 13 has a pivot hole 131. A pushing portion 121 is disposed to an upper end of the push member 12 while a lower end of the push member is provided with an embedding portion 122, and the embedding portion 122 protrudes the leaning portion 111.

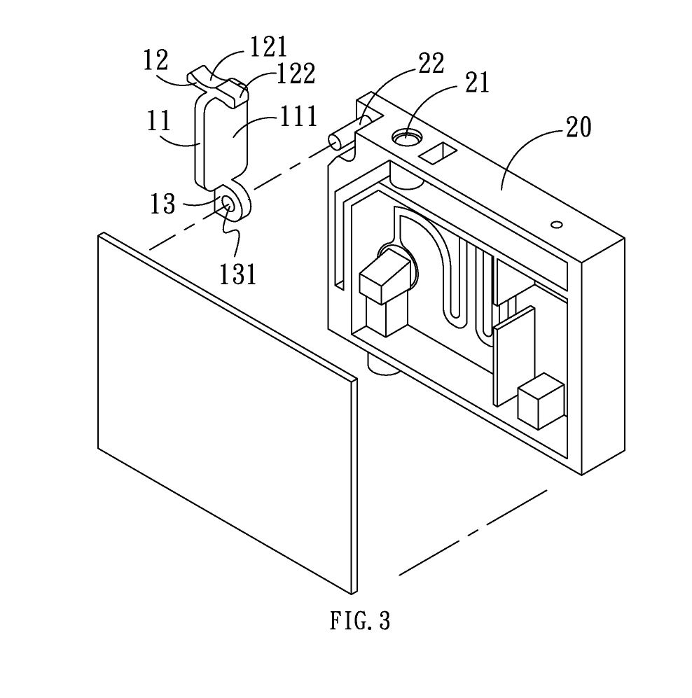

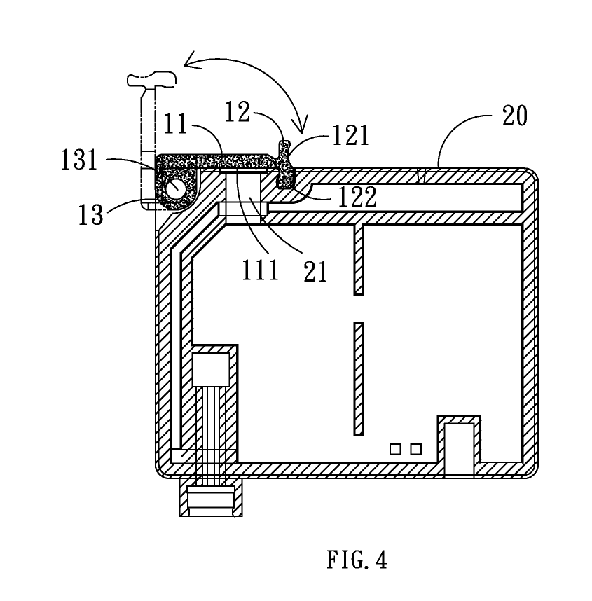

Accordingly, the structure is applied to the ink cartridge. With reference to FIG. 3 and FIG. 4, the pivot cover 10 can be assembled to the ink cartridge 20 to cover an ink refill opening 21. The fastening member 13 is fastened to the ink cartridge 20 through the shaft portion 22 of the ink cartridge 20 passing through the pivot hole 131. A lower end edge of the fastening member 13 is a circular arc surface. While pushing the pushing portion 121, the push member 12 drives the fastening member 13 based upon the axle core of the pivot hole 131 and movably pivots though the circular arc surface to allow the pivot cover 10 to achieve the movement of rotably opening and closing so that the embedding portion 122 can be lodged and positioned and the leaning portion 111 can tightly close the ink refill opening 21 of the ink cartridge 20.

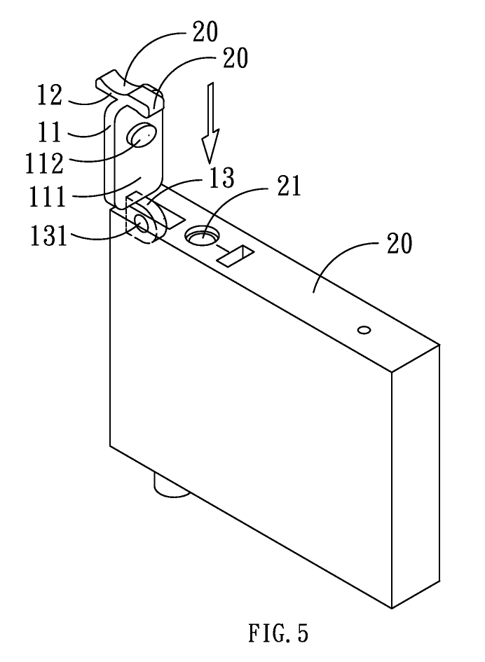

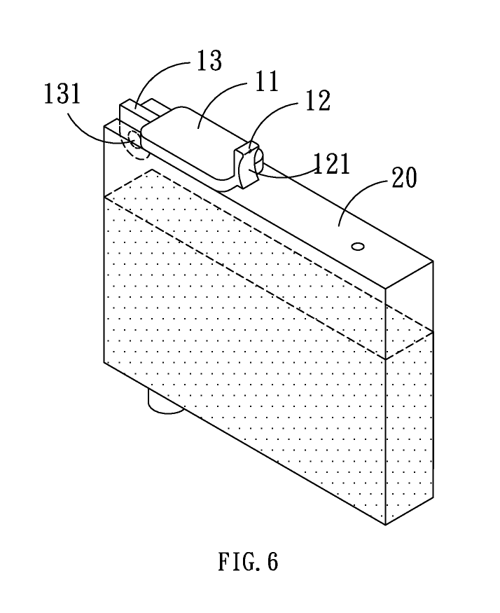

Moreover, the embodiment of the invention is shown in FIG. 5 and FIG. 6, the pushing portion 111 can have a concave arc surface that incorporates with human factor engineering. When a finger leans against the pushing portion 121, the finger can be easily positioned due to the concave arc surface. When a force is imposed, the finger may not slip from the pushing portion 121. The pushing portion can be easily operated and pushed. In addition, the lower end of the leaning portion 111 can be provided with a plug portion 112. The plug portion 112 can correspond to a bore diameter of the ink refill opening 21 to tightly close to prevent ink within the ink cartridge 20 from being leaked. The whole structure can conveniently fill ink in the ink cartridge 20. When the ink is completely filled, the pivot cover 10 can be lightly pushed. The problem of being unable to find the plug can be avoided while pulling the plug out with respect to ink-filling.

The pivot cover structure for ink cartridge of the present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A pivot cover structure for an ink cartridge, the pivot cover comprising:
a cover body having a leaning portion, a push member extended from an end of the cover body while a fastening member extended from another end of the cover body, the fastening member having a pivot hole, a pushing portion disposed to an upper end of the push member, an embedding portion disposed to a lower end of the push member, wherein while pushing the pushing portion, the embedding portion of the cover body rotates to achieve positioning through the pivot hole so that the leaning portion covers the ink cartridge.

2. The pivot cover structure for an ink cartridge as recited 1, wherein the leaning portion is provided with a plug portion.

3. The pivot cover structure for an ink cartridge as recited 1, wherein the pushing portion is a concave arc surface.

4. The pivot cover structure for an ink cartridge as recited 1, wherein the fastening member is fastened by the pivot hole.

5. The pivot cover structure for an ink cartridge as recited 1, wherein the embedding portion protrudes the leaning portion.

6. The pivot cover structure for an ink cartridge as recited 1, wherein a lower end edge of the fastening member is a circular arc surface.

7. The pivot cover structure for an ink cartridge as recited 1, wherein the push member and the fastening member are respectively extended from two ends of the cover body and are formed by integrated modeling.

8. A pivot cover structure for an ink cartridge composed of the pivot cover and the ink cartridge; the characterized in that:
the pivot cover composed of a cover body having a leaning portion, a push member extended from an end of the cover body, a fastening member extended from another end of the cover body, the fastening member having a pivot hole, a pushing portion disposed to an upper end of the push member, an embedding portion disposed to a lower end of the push member;
the ink cartridge being a cartridge body and having an ink refill opening, a lodging portion and a shaft portion, wherein the shaft portion passes through the pivot hole to achieve fastening to pivotally rotate the cover body so that the embedding portion is embedded into the lodging portion to allow the leaning portion to tightly close the ink refill opening.

9. The pivot cover structure for an ink cartridge as recited 8, wherein the leaning portion is provided with a plug portion, and the plug portion corresponds to a pore diameter of the ink refill opening to tightly close.

10. The pivot cover structure for an ink cartridge as recited 8, wherein the pushing portion is a concave arc surface.

11. The pivot cover structure for an ink cartridge as recited 8, wherein the fastening member is fastened by the pivot hole.

12. The pivot cover structure for an ink cartridge as recited 8, wherein the embedding portion protrudes the leaning portion.

13. The pivot cover structure for an ink cartridge as recited 8, wherein a lower end edge of the fastening member is a circular arc surface.

14. The pivot cover structure for an ink cartridge as recited 8, wherein the pushing member and the fastening member are respectively extended from two ends of the cover body and are formed by integrated modeling.
